(19) United States
(12) Patent Application Publication
(10) Pub. No.: US 2026/0211669 A1
(43) Pub. Date: Jul. 23, 2026

(54) PROMPT OPTIMIZATION FOR CODE ASSISTANTS IN DISTRIBUTED DEVELOPMENT ENVIRONMENTS

(71) Applicant: SAP SE, Walldorf (DE)

(72) Inventors: Marco Haupt, Biblis (DE); Leon Knorr, Waghäuse (DE); Kai Patrick Reisert, Hemsbach (DE); Cristina Buchholz, Reilingen (DE)

(21) Appl. No.: 19/035,144

(22) Filed: Jan. 23, 2025

(51) Int. Cl. G06F 8/71; G06F 8/41; G06F 40/30

(52) U.S. Cl. CPC G06F 8/71; G06F 8/427; G06F 40/30

(57) ABSTRACT

A prompt optimization interface retrieves semantic information characterizing a source code under development that includes code entities. A code suggestion system coupled to the prompt optimization interface, generates, from the semantic information, a dependency graph exposing relations and dependencies between the code entities. The code suggestion system generates a ranked list of code entities indicative of a relevance of each code entity of the code entities in the dependency graph based on a relevance to a query code entity. The code suggestion system minimizes the dependency graph using the ranked list of code entities and a context of the query code entity for generating a minimized dependency graph to be within a set window. The code suggestion system converts the minimized dependency graph into a prompt format processable by a large language model to generate matching code for the source code under development.

### TECHNICAL FIELD

The present disclosure relates to source code analysis. More particularly, implementations of the present disclosure are directed to generation of optimized prompts for code assistants in distributed development environments.

### BACKGROUND

Large language models (LLMs) have been widely adopted across numerous domains and industries, revolutionizing various tasks. Some LLMs have been used to create code assistants, designed to provide code suggestions. The low accuracy and poor quality of code suggestions have hindered the usage of code assistants. The accuracy and quality of code suggestions are dependent on the amount and type of information provided in the input prompt. Vague or incomplete prompts can lead to multiple interpretations, causing the system to generate suggestions that may not align with the code being developed. Detailed and specific input prompts can lead to the generation of applicable code suggestions.

### SUMMARY

Implementations of the present disclosure are directed to techniques and tools for source code analysis. More particularly, implementations of the present disclosure are directed to generation of optimized prompts for code assistants in distributed development environments.

In some implementations, a computer-implemented system, includes: a prompt optimization interface retrieving semantic information characterizing a source code under development, the source code including code entities, and a code suggestion system coupled to the prompt optimization interface, the code suggestion system generating, from the semantic information, a dependency graph exposing relations and dependencies between the code entities, the code suggestion system generating a ranked list of code entities indicative of a relevance of each code entity of the code entities in the dependency graph based on a relevance to a query code entity, the code suggestion system minimizing the dependency graph using the ranked list of code entities and a context of the query code entity for generating a minimized dependency graph to be within a set window, and the code suggestion system converting the minimized dependency graph into a prompt format processable by a large language model to generate matching code for the source code under development.

In some aspects, the code entities include any of classes, methods, functions, forms, statements, variable definitions, and type definitions (e.g., type aliases, structure definitions, table definitions). In some aspects combinable with any of the previous aspects, the dependency graph includes a directed multigraph and wherein each node of the directed multigraph represents a code entity, and each edge represents a dependency between two code entities. In some aspects combinable with any of the previous aspects, the code suggestion system parses the semantic information to extract the code entities. In some aspects combinable with any of the previous aspects, the code suggestion system filters a portion of the code entities to reduce the size of the dependency graph. In some aspects combinable with any of the previous aspects, the code suggestion system generates the ranked list of code entities by applying machine learning models for semantic search, or by using statistical models, or by applying rule-based approaches. In some aspects combinable with any of the previous aspects, the computer-implemented system further includes a training engine training the LLM using the semantic information from a Python wrapper library. In some aspects combinable with any of the previous aspects, training the LLM is aligned with inferring the semantic information using an application repository.

In some implementations, a computer-implemented method includes: retrieving, from a prompt optimization interface, semantic information characterizing a source code under development, the source code including code entities, generating, from the semantic information, a dependency graph exposing relations and dependencies between the code entities, generating a ranked list of code entities indicative of a relevance of each code entity of the code entities in the dependency graph based on a relevance to a query code entity, minimizing the dependency graph using the ranked code entities and a context of the query code entity for generating a minimized dependency graph, and converting the minimized dependency graph into a prompt format processable by a large language model to generate matching code for the source code under development.

The foregoing and other implementations can each optionally include one or more of the following features, alone or in combination. In particular, implementations can include all of the following features:

In a first aspect, combinable with any of the previous aspects, the code entities include any of classes, methods, variables, and database tables. In some aspects combinable with any of the previous aspects, the dependency graph includes a directed multigraph and wherein each node of the directed multigraph represents a code entity, and each edge represents a dependency between two code entities. In some aspects combinable with any of the previous aspects, the code suggestion system parses the semantic information to extract the code entities. In some aspects combinable with any of the previous aspects, the code suggestion system filters a portion of the code entities to reduce the size of the dependency graph. In some aspects combinable with any of the previous aspects, the code suggestion system generates the ranked list of code entities by applying machine learning models for semantic search, or by using statistical models, or by applying rule-based approaches. In some aspects combinable with any of the previous aspects, the computer-implemented method further includes training the LLM using the semantic information from a Python wrapper library. In some aspects combinable with any of the previous aspects, training the LLM is aligned with inferring the semantic information using an application repository.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described approach advantageously provides an efficient automatic generation of code suggestions based on optimized prompts for LLMs. The generated code assistants are designed to enhance code development efficiency by offering accurate and relevant code suggestions, detailed code explanations, and even by generating entire code snippets, such as test cases. The described approach enhances the performance of code assistants by automatically refining prompts for large language models to ensure that the prompts are both concise and rich in relevant information. The described prompt optimization leverages a highly integrated and coherent system that securely, holistically, and synergistically accesses multiple available information sources for retrieving relevant data. The relevant information is inserted depending on a cursor position within the source code under development, wherein insignificant parts are removed from the current file and essential parts from other files are automatically retrieved and integrated. The extracted relevant data inherently integrates data corresponding to particular code types resulting in highly relevant code suggestions. The described implementations eliminate the re-implementation of the logic for each individual tech stack, reducing the development and support overhead and latency associated with processing multiple models, facilitating faster development cycles and efficient prototyping, and testing in distributed environments.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of optimization of prompts for code assistants in distributed development environments, according to some implementations of the present disclosure.

FIG. 2 is a block diagram of an example system architecture for optimization of prompts for code assistants in distributed development environments, according to some implementations of the present disclosure.

FIG. 3 is a flowchart of an example process for generation of optimization of prompts for code assistants in distributed development environments, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to generating software code suggestion using large language models (LLMs). More particularly, implementations of the present disclosure are directed to generation of optimized prompts for LLM based code assistants in distributed development environments.

The code assistants include a prompt optimization interface that retrieves semantic information characterizing a source code under development that includes code entities. The code assistants further include a code suggestion system that is coupled to the prompt optimization interface. The code suggestion system generates, from the semantic information, a dependency graph exposing relations and dependencies between the code entities. The code suggestion system generates a ranked list of code entities using a single or a combination of ranking models to determine a relevance of each code entity with regards to a query code entity. The code suggestion system minimizes the dependency graph using the ranked list of code entities and a context of the query code entity for generating a minimized dependency graph to be within a set window. The code suggestion system converts the minimized dependency graph into a prompt format processable by LLMs to generate matching code for the source code under development.

LLMs have been used as code assistants to determine a matching portion of a software code under development. LLMs facilitate extraction of code suggestions based on prompts. Even though commonly available LLMs excel at summarizing large amounts of text, traditional usage of LLMs lacks an understanding of prompt syntaxes requesting code suggestions and rules associated with data and proprietary languages, such as Advanced Business Application Programming (ABAP) and core data services (CDS) provided by SAP SE of Walldorf, Germany. This is addressed in the described approach. The accuracy and relevance of code suggestions depends on the syntactic structure and content of prompts. The accuracy and relevance of code suggestions are also limited by access to libraries and databases. Addressing the limitations of LLM generated code suggestions, the generation of LLM prompts for code suggestions described in the present disclosure enhance the effectiveness and efficiency of code suggestions, optimizing the development of complex software systems in a distributed development landscape, where development objects are shared between developers in a central repository.

The described approach provides an efficient automatic generation of optimized LLM prompts for code suggestions that eliminates the need for implementation duplicates, since replication of the context injection logic in both a library for training and on an application server is avoided. The replication removal advantageously facilitates usage of different technological stacks (e.g., proprietary programming languages and architectures) by the application server and by the training pipeline in distributed development landscapes. The described automatic generation of LLM prompts for code suggestions eliminates the prerequisite for LLMs to learn to understand both source code and structural information provided in a separate format, reducing the computational overhead and latency associated with processing multiple models, while increasing the efficiency of the analysis with improved accuracy.

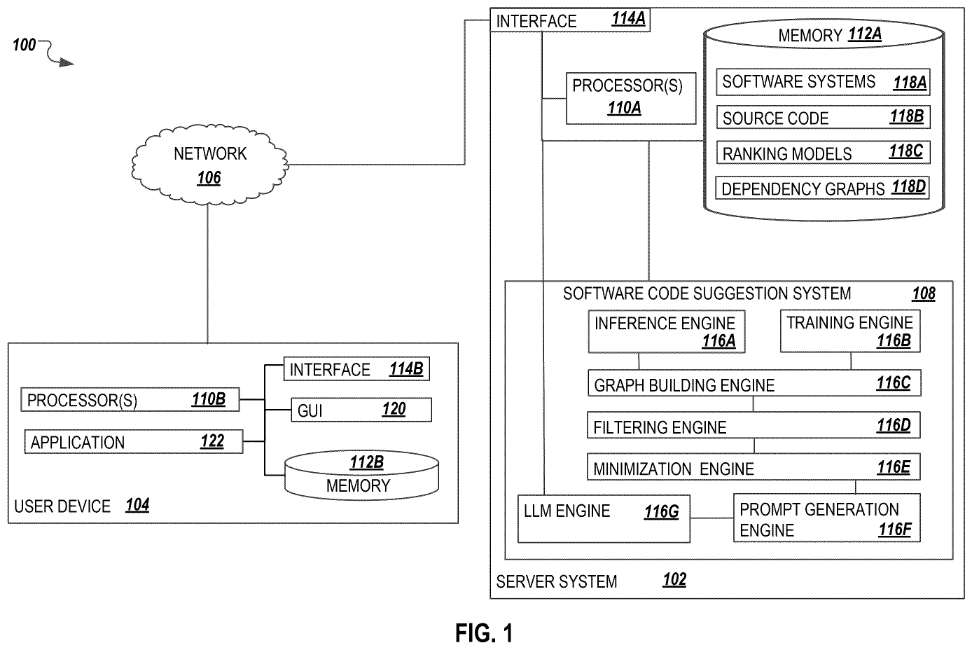

FIG. 1 is a block diagram of an example system 100 for optimization of prompts for code assistants in distributed development environments, according to some implementations of the present disclosure. Specifically, the illustrated example system 100 includes or is communicably coupled with a server system 102, an end-user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool of a distributed development environment (e.g., a cloud-based platform like the SAP Business Technology Platform (BTP), ABAP environment). In general, server systems 102 accept requests for application services including generation of code suggestions and provides such services to any number of end-user devices 104 (e.g., the user device 104 over the network 106). In accordance with implementations of the present disclosure, and as noted above, the server system 102 can host a solution environment that can be a cloud environment providing software applications, systems, and services that can be developed in multiple software development environments that share software code, collaborate on changes, and manage development processes in a distributed manner. In some instances, the server system 102 can support configuring of various tenants of different types, as well as services of different types that are integrated in customer integration scenarios and support execution of defined processes associated with generation of code suggestions. For example, the server system 102 includes a software code suggestion system 108, a processor 110A, a memory 112A, and an interface 114A.

The software code suggestion system 108 can include a prompt optimization interface 116A, a training engine 116B, a graph building engine 116C, a filtering engine 116D, a minimization engine 116E, a prompt generation engine 116F, and a LLM engine 116G. The software code suggestion system 108 is coupled to the processor 110A, the memory 112A, and the interface 114A for generation of code suggestions using data stored in the memory 112A. The memory 112A can include software systems 118A, source codes 118B, models 118C, and dependency graphs 118D.

For example, user devices 104 that form software development environments generate requests for code suggestions for a software source code 118B under development compatible with the software system 118A. The software code suggestion system 108 can use the inference engine 116A (prompt optimization interface) to run a model in a production environment, without gradient calculation for weight updates. The inference engine 116A can transmit the data to the graph building engine 116C to generate a directed multigraph of dependencies. The graph building engine 116C can send the directed multigraph of dependencies to the filtering engine 116D to filter out irrelevant code entities and dependencies from the dependency graph in a static-and rule-based manner using ranking models 118C. The filtering engine 116D can be an optional component of the software code suggestion system 108, which can be used to apply static and rule-based filters on the graph, to reduce the amount of data which is processed further by the ranking models. The filtering engine 116D can be used to reduce compute costs and latency, as rule-based approaches use less computations and storage than statistical or machine learning based ranking models. The filtering engine 116D can send the dependency graph 118D to the minimization engine 116E for further processing and to the memory 112A for storage. The minimization engine 116E can minimize the dependency graph 118D using a rank and size assigned to each code entity. The minimization engine 116E can send the minimized dependency graph 118D to a code generator, which generates source code using the information provided by the graph, as well as the original input and the data gathered during source code analysis. The generated source code is converted to the correct prompt format, by the prompt generation engine 116F, for example, by splitting the prompt up based on the original input into prefix and suffix for a fill-in-the-middle (FIM) task. The resulting optimized prompt is provided by the prompt generation engine 116F, to the LLM engine 116G.

The prompt generation engine 116F can generate, using contexts, and a prompt template, a prompt for the LLM engine 116G. The LLM engine 116G can generate code suggestions and textual descriptions of the code suggestions associated with the code under development at the user device 104. The LLM engine 116G can be deployed as an API, facilitating integration into the development environment of the user device 104. The API deployment of the LLM engine 116G facilitates access to code suggestions in real-time. The software code suggestion system 108 can transmit the code suggestions and textual descriptions of the code suggestions to be displayed on the graphical user interface (GUI) 120 of the user device 104. For example, the software code suggestion system 108 of the present disclosure is coupled to the interface 114A to provide an integrated user interface (UI) rendering solution within a digital assistant that leverages generative LLM to infer code suggestions compatible with the software system 118A and optimize prompt of the code suggestions for an efficient development of the software source code 118B. More particularly, the software code suggestion system 108 of the present disclosure calls the prompt generation engine 116F to leverage the ability of the prediction engines including large language models (LLM) 116F to generate code suggestions.

In general, the end-user device 104 includes an electronic computer device operable to receive, transmit, process, and store any appropriate data associated with the system 100 of FIG. 1. The end-user device 104 is intended to encompass any client computing device such as a laptop/notebook computer, wireless data port, smart phone, personal data assistant (PDA), tablet computing device, one or more processors within these devices, or any other suitable processing device. The end-user device 104 includes an interface 114B, a processor 110B, a memory 112B, and a GUIs 120. The end-user device 104 can include one or more applications 122. The application 122 can be any type of application including a service providing access to an inference engine that allows a user device to develop software source code 118B and automatically request code suggestions. In some implementations, an application 122 can use parameters, metadata, and other data to access the software code suggestion system 108 from the server system 102. In some instances, an application 122 can be an agent or client-side version of the one or more enterprise applications running on the server system 104 supporting the distributed development environment.

In accordance with implementations of the present disclosure, the application 122 includes a digital assistant that enables interactions with the user device 104. For example, and as described in further detail herein, the digital assistant of the user device 104 can receive software code suggestions. In some examples, one or more software code suggestions can include software code suggestions that are presented as a graphical representation in the GUI 120. In accordance with implementations of the present disclosure, the GUI 120 can present software code suggestions as a graphical representation in a popover container within a software development window. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAPUI5 provided by SAP SE of Walldorf, Germany.

In some implementations, any, or all, of the components of the example system 100, both hardware or software (or a combination of hardware and software), can interface with each other or the interface(s) 114A, 114B (or a combination of both) over the network 106 for generation of code suggestions. The functionality of the end-user device 104 can be accessible for all service consumers using the application 122 that transmits prompts to the software code suggestion system 108 to generate code suggestions.

For example, the end-user device 104 can include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122. The GUI 120 can provide the user with an efficient and user-friendly presentation of code suggestions provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110a, 110B included in the end-user device 104 can be a central processing unit (CPU), an application specific integrated circuit (ASIC), a field-programmable gate array (FPGA), or another suitable component. Each processor 110A, 110B included in the end-user device 104 executes instructions and manipulates data to perform the operations of the end-user device 104, respectively. Specifically, each processor 110A, 110B included in the end-user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the end-user device 104). Specifically, each processor 110A, 110B executes the functionality required to receive and respond to requests from the respective system (the server system 102, the end-user device 104), for example.

Interfaces 114A, 114B are used by the server system 102, the end-user device 104, respectively, for communicating with other systems in a distributed environment—including within the system 100 - connected to the network 106. The interfaces 114A, 114B each include logic encoded in software and/or hardware in a suitable combination and operable to communicate with the network 106. More specifically, the interfaces 114A, 114B can each include software supporting one or more communication protocols associated with communications such that the network 106 or interface's hardware is operable to communicate physical signals within and outside of the illustrated system 100.

The memory 112A, 112B can include any type of memory or database module and can take the form of volatile and/or non-volatile memory including, without limitation, magnetic media, optical media, random access memory (RAM), read-only memory (ROM), removable media, or any other suitable local or remote memory component. The memory 112A, 112B can store various objects or data, including caches, classes, frameworks, applications, backup data, data objects, jobs, web pages, web page templates, database tables, database queries, repositories storing static and/or dynamic information, and any other appropriate information including any parameters, variables, algorithms, instructions, rules, constraints, or references thereto associated with the purposes of the server system 102, or the end-user device 104, respectively.

There can be any number of end-user devices 104 and server systems 102 associated with, or external to, the system 100, forming a distributed development environment where software code is developed at remotely located end-user devices 104. Additionally, the example system 100 can include one or more additional user devices external to the illustrated portion of system 100 that are capable of interacting with the system 100 using the network(s) 106. Further, the term “client,” “user device,” and “user” can be used interchangeably as appropriate without departing from the scope of the disclosure. Moreover, while user device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single end-user device 104, the system 100 can be implemented using a single, stand-alone computing device, two or more servers 102, or multiple user devices. The server system 102, and the end-user device 104 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

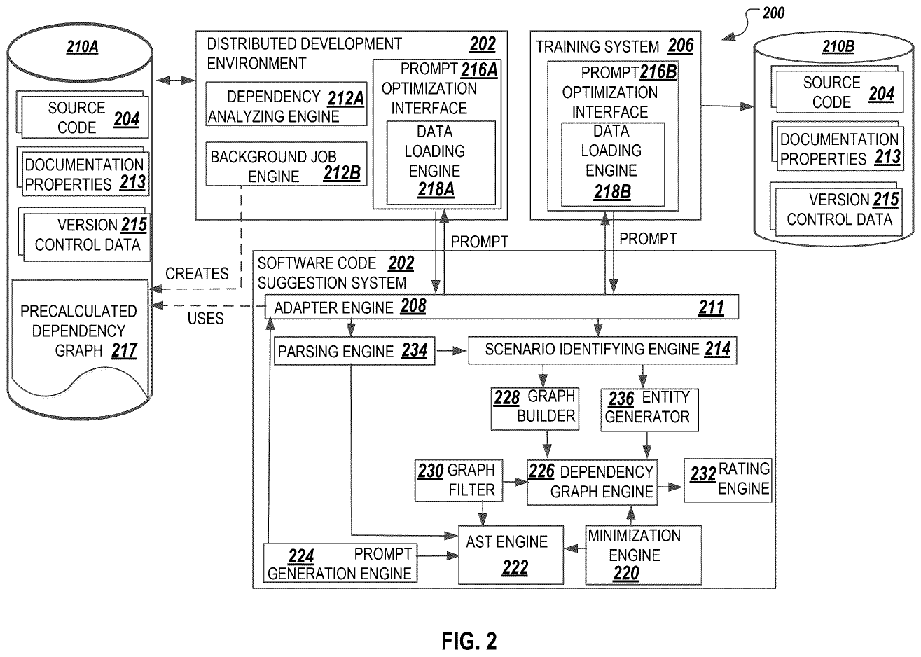

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP, ABAP OO (Object Oriented), any suitable version of a fourth-generation programming language (4GL), as well as others. While portions of the software illustrated in FIG. 1 are shown as individual modules that implement the various features and functionality through various objects, methods, or other processes, the software can instead include multiple sub-modules, third-party services, components, libraries, and such, as appropriate. Conversely, the features and functionality of various components can be combined into single components as appropriate. The communication between the end user device 104 and the server system 102 can include several different communication protocols configured to optimize generation of code suggestions, as further described in detail with reference to FIGS. 2-4.

FIG. 2 is a block diagram of an example system architecture 200 for generation of optimization of prompts for code assistants in distributed development environments, according to some implementations of the present disclosure. The example system architecture 200 includes a distributed development environment 202 (e.g., including the inference engine 116A described with reference to FIG. 1) wherein a source code file 204 is generated, an inference engine, a training system 206 (e.g., including the training engine 116B described with reference to FIG. 1), a software code suggestion system 208 (e.g., software code suggestion system 116C described with reference to FIG. 1), and memory 210A, 210B.

The distributed development environment 202 includes a dependency analyzing engine 212A, a background job engine 212B, and a prompt optimization interface 216A including a data loading engine 218A. The source code dependency analyzing engine 212A performs functions to assist in development of the source code 204 and management of the relationships between different parts of the source code using documentation properties 213 and version control data 215. The source code dependency analyzing engine 212A can perform dependency extraction to identify and extract dependencies between multiple code entities such as files, classes, methods, and variables, which assist with understanding how different parts of the codebase interact with each other. The source code dependency analyzing engine 212A can perform an architecture analysis that evaluates the overall architecture of the software to ensure that the source code adheres to design principles and associated rules by checking for proper layering, modularity, and adherence to architectural patterns. The background job engine 212B can handle tasks that can run independently of the main software development functions, such as task scheduling, asynchronous processing, resource management, monitoring, logging, and security operations. The background job engine 212B can generate a precalculated dependency graph 217.

Each of the distributed development environment 202 and the training system 206 include a prompt optimization interface 216A, 216B including a data loading engine 218A, 218B. The prompt optimization interfaces 216A, 216B (designed as APIs) perform similar sets of functions, which provide the data loading engines 218A, 218B, to load additional sources and semantic information, as well as the interface between the respective system and the kernel implementation.

The data loading engine 218A of the distributed development environment 202 loads the data directly from the memory 210A, which is an application repository configured to store particular file extensions: *.DLL, *.LIB, *.SLIB and supports the API functionality and various interfaces that integrate the library into a particular environment. The memory 210A includes the source code 204, along with semantic information. The semantic information retrieved, by the distributed development environment 202, from the memory 210A describes the identifiers, types, database tables, references, and relationships between the objects in the source code of an application, as well as global system objects, such as system classes or database tables. The distributed development environment 202 provides enriched context used during inference, facilitating the software code suggestion system 208 to use the additional context to generate more accurate and relevant responses.

If the source code repository is inaccessible by the memory 210A, 210B, the prompt optimization interfaces 216A, 216B provide it with at least the content of the source code file 204 being processed, the current cursor position, and some metadata for the transferred source code as input. If the memory 210A, 210B has access to the entire repository, the metadata can be omitted because it can be determined from the repository. If a user selection is not available, the user selection has zero-width and corresponds to the cursor position. The metadata is used to include code entities in the prompt that are used within the transferred source code and are defined outside of it. The code entities are defined in the same programming language as the passed code, eliminating the need and overhead for a meta language (like JSON or XML). The metadata can be at least as comprehensive as to be able to generate complete and valid source code sections from it. The generated code can be simplified to form an approximate match for to the actual code. For example, type aliases can be resolved directly, and suitable type mappings can be performed. The metadata can include at least semantic information about the signatures of used methods, functions, forms, routines, or similar, and the types of all identifiers. The metadata can include descriptions of the source code sections that are outside the source code (e.g., Doxygen, ABAP short texts). Other sources of information can also be useful for identifying other relevant code sections. For example, in a test-driven environment, the set of all previous changes in connection with the feature to be implemented (short: diff) can be useful. Such a diff is available in common version control systems. Frameworks and libraries can contain a large number of dynamic statements that are only known at program runtime and cannot be statically evaluated. Hooks can be used to retrieve the associated entities (classes, methods, functions, forms, type definitions, or descriptive texts) based on user-or application-specific rules.

The data loading engine 218B of the training system 206 loads the same information from the memory 210B (e.g., a prefabricated data-dump), which includes the source code 204, as well as a set of semantic information. The semantic information retrieved, by the training system 206, from the memory 210B mirrors the information provided by the API implementation—on the application server. The original parts of the input prompt, prefix, middle and suffix, which include the current unprocessed source code sources, along with the semantic information are transmitted to the software code suggestion system 208. The training system 206 exposes the LLM to enriched contexts during training, facilitating the LLM to learn to work with more comprehensive prompts 212. The training system 206 trains the LLM to understand that prompts 212 can include more information than just the immediate code snippets, improving the ability of the LLM to generate responses based on richer contexts. In some implementations, instead of training LLM to generate complete responses from scratch, the LLM is trained by the training system 206 to fill in the middle of a given context. The fill in the middle approach assists the training system 206 to efficiently integrate additional information into its responses, making the LLM more versatile and effective in handling complex prompts.

The source code files 204 can include new source code files generated for the software systems (e.g., software systems 118A described with reference to FIG. 1) or changed source code files of software systems. The source code files 204 include portions of a software source code under development including one or more completed code segments and missing one or more intended code segments planned to be added. The completed code segments can include parts of the code that have been fully developed, tested, and are functioning as intended. The completed code segments can include functions, classes, or modules that perform particular tasks within the software. The incomplete code segments can include placeholders or partially written code that indicate where additional functionality is planned to be added. The source code files 204 include comments describing the source code file, the completed code segments and the intended code segments planned to be added.

Comments can be included within the source code files 204 to explain the purpose of particular sections, outline the logic, or provide instructions for future development. The incomplete code segments can include comments or notes explaining what needs to be implemented for source code completion. New source code files are entirely new additions to the software systems, being stored in the memory, representing new features or components being integrated into the existing codebase. The changed source code files refer to source code files that were previously stored in the memory and were modified. The modifications of the changed source code files include any combination of additions and deletions of code segments. The modifications can range from minor changes to substantial changes, reflecting updates, bug fixes, or enhancements to the software systems. The changed source code files can include version control markers or annotations indicating changes, branches, or merge points. The source code files 204 can be organized in a way that reflects the overall architecture of the software, with clear separation between different components and logical groupings of related code to facilitate software development in the distributed development environment by indicating what has been completed and what is planned to be developed and added to the source code.

The software code suggestion system 208 provides the main functionality of the context injection frame-3 work. The software code suggestion system 208 can be implemented in a low-level language, such as C++ or Rust, which provides bindings and APIs to interact with both the distributed development environment 202 and the training system 206, eliminating duplication in both a wrapper library for training and on the application server. During inference, the distributed development environment 202 is coupled to the software code suggestion system 208 that is part of the application server kernel, and can be accessed directly by a kernel method call. During training, the training system 206 is coupled to the software code suggestion system 208 that is provided using a Python library, which can be integrated into any (python) based training pipeline. In some implementations, other languages can also be used, as long as there is support for the respective language bindings. Besides the respective bindings for both the application server and the wrapper library, the kernel implementation provides the main functionality of the context injection framework.

The software code suggestion system 208 includes an adapter engine 211, a scenario identifying engine 214, a minimization engine 220 (e.g., minimization engine 116E described with reference to FIG. 1), an AST engine 222, a prompt generation engine 224 (e.g., prompt generation engine 116F described with reference to FIG. 1), a dependency graph engine 226 (e.g., graph building engine 116C described with reference to FIG. 1), a graph builder 228 (e.g., graph building engine 116C described with reference to FIG. 1), a graph filtering engine 230 (e.g., filtering engine 116D described with reference to FIG. 1), a rating engine 232 (e.g., filtering engine 116D described with reference to FIG. 1), a parsing engine 234, and an entity generator 236.

The adapter engine 211 manages the (protocol) version between the prompt optimization interface 216A and the memory 210A, selecting the correct implementation of the graph builder, the graph filter, the rating engine, the minimization engine, and the entity generator. The memory 210A can be updated independently of the distributed development environment and vice versa. The version control data 215 indicates the versioning of the source code under development and the adapter engine 211 selects the correct implementations depending on the version. The adapter engine 211 enhances the flexibility of the software code suggestion system 208 by accessing a prompt optimization library and using a precalculated dependency graph that is generated by the background job engine 212B and provided to the parsing engine 234. The scenario identifying engine 214 uses pattern recognition and scenario matching to match the current coding scenario with predefined scenarios or use cases to suggest appropriate code snippets or solutions that optimize suggestions of the software code suggestion system 208. The entity generator 236 can generate code entities matching the scenario identified by the scenario identifying engine 214. The entity generator 236 can send the code entities to the graph builder 228.

The graph builder 228 processed the received source code and generates a graph that defines the relations and dependencies between different code entities of the source code received from the distributed development environment 202 and the training system 206. For example, the graph builder 228 calculates a directed multigraph each time the API is called. The graph builder 228 processes the source code files, by using a lexical analyzer that scans the source code files and converts the source code into a series of tokens corresponding to code entities. The code entities can include classes, methods, variables, database tables, and other source code fragments. The graph builder 228 can receive code entities parsed by the parsing engine 234 that processes the tokens and arranges the tokens into a hierarchical structure based on the grammar of the programming language. The hierarchical structure generated by the graph builder 228 can be a tree representation of the source code files 204 including an abstract syntactic structure of the source code files 204. Each node of the directed multigraph represents a code entity, in which each edge represents a dependency between two code entities. The graph is a directed multigraph, meaning that between two nodes, an edge can exist multiple times. For example, if a first method A calls a second method B multiple (e.g., 10) times, the dependency graph includes 10 directed edges from the first node A to the second node B.

For different use-cases, different dependency graph builders can be implemented which can build use-case specific graphs, depending on the requirements of the respective use-case. The use-case specific graphs can include particular code-entities and dependencies. The dependency graph is built according to a standard format for all use cases, having weights that are different or adjusted depending on the requirements of the respective use-case. The weighted dependency graph can either be computed regularly in advance, on-demand specific for the given prompt or as a combination of both. The context injection framework facilitates the inclusion of the context information, which is not only based on the current code snippet, but also on a broader context the software source code file 204 is being developed in, such as particular system development objects. The context injection framework indicates parameters of configurable enterprise software, where the control flow can be highly dependent on configurations, user roles and custom extensions. The context can be defined as being independent of membership concepts applied by a particular language. The affiliation to one or more structuring schemes (e.g., packages, namespaces, support components) can be taken into account when weighting the code components. Local systems can use a compressed representation of current open development tabs indicative of the respective context.

The graph filtering engine 230 can execute a pre-processing step to filter out irrelevant code entities and the dependency graph engine 226 analyzes the dependencies between the code entities to generate the dependency graph in a static-and rule-based manner. For example, the dependency graph engine 226 creates a complex dependency graph that can be persisted and considered if required. The more frequently the entire dependency graph is calculated, the more up to date the information it contains. The graph filtering engine 230 can apply filtering, which can include removing methods, classes, forms, or interfaces which are unrelated to the user selection. The graph filtering engine 230 can be used to filter out the code entities identified as being unreachable by traversing the graph or where the distance to the current code entity exceeds a set threshold. The graph filtering engine 230 can prune unnecessary code entities (at different node levels ( ) of the dependency graph to simplify the dependency graph. The graph filtering engine 230 can reduce the size of the dependency graph, decreasing the computational complexity of the subsequent processing steps executed by the software code suggestion system 208, in the context injection framework.

The rating engine 232 uses one or more interchangeable rating models configured to estimate the importance of each code entities in the dependency graph based on a respective relevance to the query code entity. The query code entity is the entity for which additional context information is requested (e.g., the code entities marked by the user selection or the cursor position). The ranking models can be implemented, by the rating engine 232, using a variety of different approaches. The ranking approaches can include machine learning models for semantic search analyzing the meaning and context of search queries and source code files (e.g., S-BERT algorithm). The ranking approaches can include statistical models that highlight terms that are significant in a particular source code file (e.g., term frequency-inverse document frequency, reference counting). The ranking approaches can include rule-based approaches (e.g. the shortest path between nodes in the dependency graph using Dijkstra algorithm), or any combination of artificial intelligence models trained to effectively rank the code entities in the dependency graph.

The code scanning engine 222 processes source code into individual tokens, such as keywords and identifiers, which are used by the parsing engine 234 to construct an abstract syntax tree (AST). The parsing engine 234 is responsible for parsing a portion of the tokens and extracting syntactic information, such as the size of each code entity to determine the structure of the source code, to identify code entities relative to context. For example, the parsing engine 234 can generate an internal representation about the structural information of the source code The AST serves as an internal representation about the structural information of the source code.

The minimization engine 220 minimizes the dependency graph, to generate a minimized dependency graph, using the rank assigned to each code entity, the respective size, and the respective neighborhood in the dependency graph. The minimization engine 220 can generate the minimized dependency graph by minimizing the dependency graph according to a set of rules, such that the token limit of the LLM is not exceeded and the most relevant context information is maintained. The minimization engine 220 generates the minimized dependency graph by traversing the graph beginning with the node of the query entity and iteratively estimating the required budget of an entity (number of tokens) and adding the most relevant tokens, which fit the remaining budget to the context until the token limit is reached. The estimation can include an accurate calculation of how many characters the resulting prompt is targeted to include. The context window of LLMs defines a particular number of tokens and the tokens of the programming language do not correspond to the tokens of the LLM.

The prompt generation engine 224 can generate, using the minimized dependency graph and a prompt template, a prompt 212 for the LLM. For example, for each query including a source code file 204 that results in a minimized dependency graph, a prompt 212 having a particular format defined by the prompt template is generated by the prompt generation engine 224. The prompt generation engine 224 can generate the prompt 212 including a prefix, a middle and a suffix. The prompt generation engine 224 can optimize the prompt 212 by creating a ranked list of pieces of code entities including information from the minimized dependency graph to be added to the context. The inherent ranking of the minimized dependency graph facilitates the prioritization of the most relevant information. The prompt generation engine 224 can optimize the prompt 212 by using context filling. For example, the ranked list of information is used to fill the context window. Information is added to the context in order of priority until the context window is full. The prompt optimization and context enrichment can include creating a prioritized list of information to enhance the context used by the LLM, both during training and inference. The prompt generation engine 224 can include a code generator, which can generate context in a common structural format such as JavaScript Object Notation (JSON) or extensible markup language (XML). The prompt generation engine 224 generates the context in the same structural language as the original input. For example, if the original input is written in ABAP, the context is also generated in ABAP.

The LLM can process the prompt 212 and additional input data (e.g., context data) to produce source code suggestions (textual descriptions of code entities formatted according to a programming language associated with the language used in the source code file 202) and send the source code suggestions to a user device. The LLM can be trainable on vast quantities of code entities (e.g., thousands of classes). The LLMs can include STARCODER, OLLAMA, CODESTRALand MISTRAL. The training of the LLM can include contextual training, the prompt generation engine 224 providing clear context for the code suggestions. For example, the prompt generation engine 224 provides prompt optimization by inserting further comments or descriptions that specify the target functionality or constraints. The context window indicates the maximum size of the input in tokens to provide the LLM. The tokens are selected to include enough information about a portion of the code surrounding a cursor or a selection within the source code under development. The LLM uses the context windows to generate code suggestions that are coherent and contextually appropriate for the source code under development. In some implementations, the LLM includes a preprocessor and/or a post-processor that mitigates a risk of LLM hallucinations and to improve formatting of the response from the LLM (e.g., based on a format chosen in a communication schema).

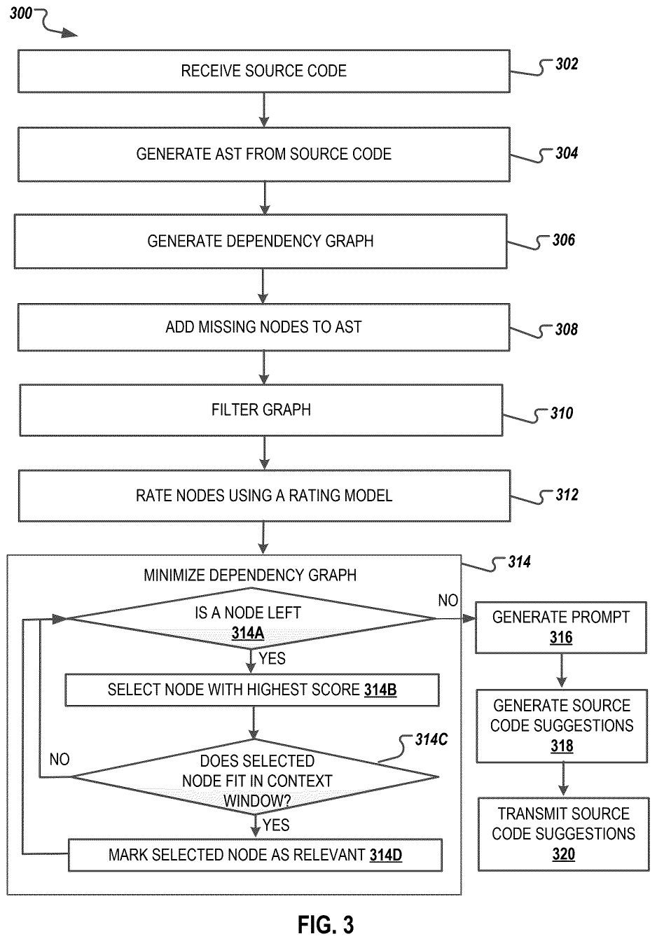

Current LLMs are usually much more sensitive to information included in the beginning (prefix) or in end (suffix) of the prompt 212. Including the cursor context in the prefix or the suffix of the prompt 212 can increase the accuracy of the code suggestions generated by the LLM. Further details regarding the generation of code suggestions, executed by the software code suggestion system 208, are provided with reference to FIG. 3.

The example system architecture 200 can be used to generate code suggestions for a code under development, such as the following code example input.
class project_order_document definition public final create public.
public section.
interfaces percentage_document.
methods is_valid returning value(bool) type abap_bool.
protected section.
private section.
data id type po_id.
data items type po_items.
endclass.
class project_order_document implementation.
method is_valid.
if id is initial. return abap_false. endif.
if items is initial. return abap_false. endif.
return abap_true.
endmethod.
method percentage_document~determine_percentage.
loop at items
endmethod.
endclass.
Within the context example, the following code example output can be generated.
“! 10-digit numeric project order ID
types po_id type n length 10.
“! item in a project order, including its label, quantity, and price
types: begin of po_item,
label type string,
quant type i,
price type p length 6decimals 2,
end of po_item.
index table of project order items
types po_items type standard table of po_item with empty key.
“! handles percentage calculations for documents
interface percentage_document public.
“! Calculates VAT with varying percentage rates per item.
methods determine_percentage.
endinterface.
“! handles order details, pricing, and percentage calculations
class project_order_document definition public final create public.
public section.
interfaces percentage_document.
“! returns true if the document is complete and valid
methods is_valid returning value(bool) type abap_bool.
protected section.
private section.
data id type po_id.
data items type po_items.
endclass.
class project_order_document implementation.
method percentage_document~determine_percentage.
loop at items
endmethod.
endclass.

Within the context example, assuming that the developer's cursor in the distributed development environment 202 is at the end of line 19 immediately after the token “items,” the “is_valid” method can be identified as not being relevant for completing the code at the cursor position. Within the context example, if the LLM input size is exceeded, the parsing engine 234 can remove it.

With continued reference to the context example, documentation from the object properties (e.g., short text) can be inserted, even in between the original code (marked by quotes). The dependency of the method to be completed on the “percentage_document” interface can be recognized and the interface definition can be inserted in the output. An internal table with the name “items” can also be used within this method, being defined within the class definition, the class type “po_items” being defined outside (e.g., in the data dictionary). The entity generator 236 generates a table type at the beginning of the file, in a form that is a suitable for mapping to the characteristics of the programming language and is independent of the terms of handling, facilitating additional context to be added in the same programming language.

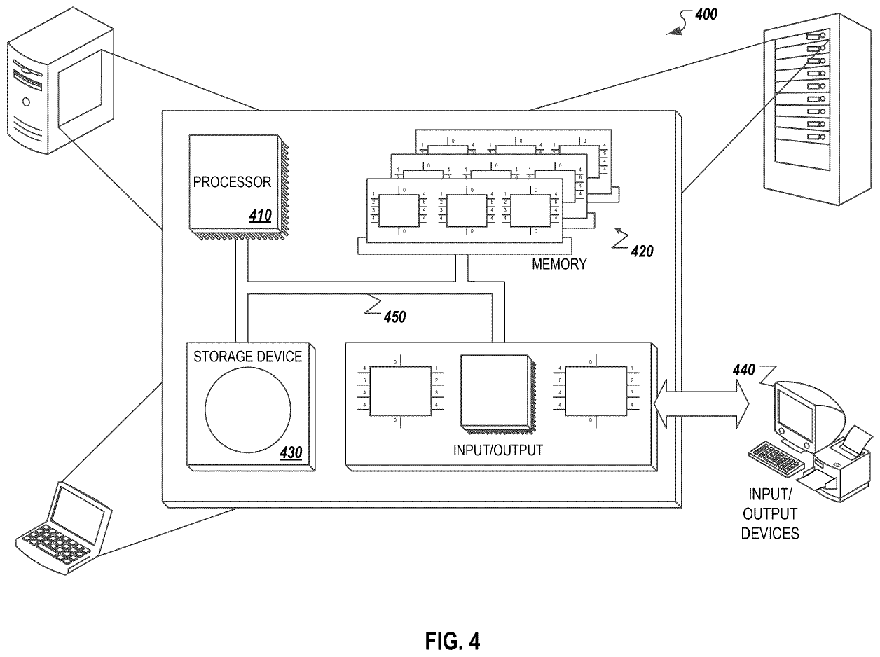

FIG. 3 is a flowchart of an example process 300 for generation of optimization of prompts for code assistants in distributed development environments, according to some implementations of the present disclosure. The example process 300 can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300 in the context of the systems described with reference to FIGS. 1, 2, and 4.

At 302, a protocol version, a portion of a source code under development, a masked code range, a chat history and source code additional data are received, by one or more processors, from a user device in a distributed development environment. In some implementations, the receipt of the source code includes receiving an identifier the source code to facilitate retrieval of the source code from a memory where the source code is stored. The source code can include software products (e.g., multiple open-source software (OSS) components which are built by independent software product providers). The portion of a source code under development can include a segment of the source code within a set window (defined based on a number of code snippets) from a cursor. The source code can be retrieved in real time, through an API of an inference engine. The source code includes code snippets (e.g., small, reusable pieces of code that can be inserted into larger programs) and one or more code entities (e.g., complex, and structured components of a codebase), such as classes, methods, variables, and database tables.

At 304, an AST is created from the source code by parsing the source code to create a tree representation of the code structure. Generating the AST includes retrieval and analysis of the semantic information associated with the source code, from an application repository (e.g., memory 210A described with reference to FIG. 2). The semantic information describes the identifiers, types, database tables, references, and relationships between the objects in the source code of an application, as well as global system objects, such as system classes or database tables. Generating the AST includes creating nodes for each construct in the source code. Each node represents a construct including an expression, statement, or declaration. Generating the AST can include parsing the source code, by the one or more processors, using the AST, to generate code snippets. Source code parsing can include extraction of syntactic information, such as the size of each code entity to determine the structure of the source code, to identify code entities relative to context, and to generate code snippets. Source code parsing can trigger a request for a code scanning engine to perform a search of the additional context information that is relevant to the ranked code entities to provide a more comprehensive understanding of the source code to effectively produce accurate and contextually relevant code snippets to assist developers in their coding tasks. The request can include a trigger to perform a search for additional context information that is relevant to the ranked code entities.

At 306, a dependency graph is generated, by the one or more processors, using a dependency graph engine that processes the parsed semantic information and extracts each code entity, along with its dependencies, and constructs the graph accordingly. The dependency graph exposes relations and dependencies between the code entities. Each node of the dependency graph represents a code entity, while each edge represents a dependency between two code entities.

At 308, missing nodes are identified and added to the AST by applying pattern matching by comparing the current AST against expected patterns or templates or by applying error detection to generate a log identifying unexpected states or difficulties in determining the context in order to continuously improve the system. The errors can indicate incomplete or incorrect syntaxes that can be corrected by adding missing nodes.

At 310, a portion of the code entities of the dependency graph is filtered, by the one or more processors, to reduce a size of the dependency graph. The filtering process can include identifying and removing nodes of the dependency graph that represent unused code entities. The unused code entities can be functions, classes, or variables that are defined but never called or referenced within the developed source code. The filtering process can include removal of edges that represent redundant or unnecessary dependencies. For example, if a dependency is only used in a test environment, it can be considered irrelevant for the main application. The filtering process can include application of any custom rules particular to the project or domain. For example, deprecated code entities or dependencies that are marked for removal can be filtered out.

At 310, a ranked list of code entities indicative of a relevance of each code entity of the code entities in the dependency graph is generated using a rating model. The rating of the nodes can be based on a relevance of the nodes to a query code entity. The ranked list of code entities can be generated by using a preprocessing model, such as machine learning models for semantic search (e.g., S-BERT), statistical models (e.g., TF-IDF, reference counting), or rule-based approaches (e.g., the shortest path using Dijkstra algorithm). The preprocessing model can be trained to retrieve semantic information from a Python wrapper library.

At 314, the dependency graph is minimized by using the ranked list of code entities and a context of the query code entity for generating a minimized dependency graph. Minimizing the dependency graph includes traversing the dependency graph beginning with the node of the query entity and iteratively estimating the required budget of an entity and adding the most relevant ones, which fit the remaining budget to the context until the token limit is reached. Minimizing the dependency graph includes selection of the most relevant nodes, relative to the token limit of the currently used LLM.

At 314A, it is determined, by the one or more processors, whether each node of the AST has been processed or if any node is left unprocessed. At 314B, in response to determining that one or more nodes are left unprocessed, a node with the highest score is selected. At 314C, it is determined, by the one or more processors, whether the rating of the selected node is above a threshold and whether the selected node fits into the context window (whether the minimized dependency graph is within limits) to ensure, that the token limits of the LLM are not exceeded, while still providing the most relevant context information. In response to determining, by the one or more processors, that the minimized dependency graph exceeds the limits, the example process 300 returns to node verification. At 314D, in response to determining that the rating of the selected node is above the threshold and that the minimized dependency graph is within limits, the selected node is marked as being relevant.

At 316, in response to determining, by the one or more processors, that all AST nodes have been processed and the minimized dependency graph is within limits, a prompt is generated, by the processor for a prediction model. The prompt can be generated by converting the minimized dependency graph into a prompt format processable by a large language model to generate matching code for the source code under development. The prompt can be generated into a format that can be used by the large language model, such as JSON or actual code, using the minimized dependency graph and a prompt template. In some implementations, the prompt includes as a prefix or as a suffix a portion of the source code proximal to the cursor to facilitate generation of relevant code suggestions relative to a cursor position within the source code under development. The prompt can include a request to generate a matching code for the source code under development according to a source code context and cursor context. In some implementations, the prompt is validated, by the processor, by processing the one or more requirements. Validation of the prompt by processing the one or more textual includes a verification of context requirements according to fields of the prompt template. The validation can be executed according to one or more conditions defining a minimum number of textual requirements to be included to enable processing of the request, such as inclusion in the request of at least a use-case for the requested code suggestion, a minimum number of code snippets within the cursor context, context inclusion, and at least one target platform or system. In some implementations, in response to determining that the prompt is missing at least one textual requirement, the process returns to receiving source code.

At 318, source code suggestions are generated using the prediction model. The prediction model can include an artificial intelligence model, such as LLMs (e.g., deep learning models). The LLM can process the prompt and additional input data (e.g., context data) to produce source code suggestions (code snippets and, optionally, code entities formatted according to a programming language associated with the language used in the source code file). The LLM uses the context windows to generate code suggestions that are coherent and contextually appropriate for the source code under development. The LLM can be trainable on vast quantities of code entities (e.g., thousands of classes). The training of the LLM can include contextual training. The training of the LLM can use the context windows to provide the LLM with enough information about a portion of the code surrounding a cursor within the source code under development. The LLM can be trained using the semantic information from a Python wrapper library. The training of the LLM can be aligned with inferring the semantic information from an application repository. In some implementations, the LLM can automatically apply a threat analysis to the developed source code and adjust the source code suggestions to minimize security threat vulnerabilities.

At 320, the source code suggestions are transmitted to the user device where the source code is under development to be displayed in real time. In some implementations, the source code can be updated, by the one or more processors, to include the source code suggestions. For example, if a vulnerability of the source code under development is detected, the source code suggestions can be automatically included in the source code to minimize its vulnerability. The automatically added source code suggestions can include an adjustment of data flow according to a secure sequence of data transmission between the system nodes to perform secure functions. The data flow can be defined by templates indicating which components can be added. The templates can correspond to particular security communication scenarios. An application invoking a sequence of the adjusted data flow can be executed. The execution of the data flow can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The source code suggestions and, if applicable, the output of the automatically embed API calls in source code can be displayed by a graphical user interface of the user device.

The example process 300 for generation of code suggestions provides an advantage of minimizing the dependency graph using the ranked list of code entities, making the example process 300 to be applicable to any LLM as it can manage the different token limits of each model effectively, without being constrained by a set token limit of a particular LLM type. As another advantage, the example process 300 is able to efficiently select most relevant context based on the relevance of the code entities to the query code entity and the current LLM use-case. In contrast to a “one-shot-fits-all” approach, where the context is always based on the current open development tabs, the context selection of the example process 300 facilitates efficient context injection pipelines for each use-case. The described context selection can be tailored to the respective LLM requirements by using different ranking models and can filter code entities differently between LLM use-cases, increasing the accuracy of the code suggestions generated by the respective LLM.

As another advantage, the example process 300 incorporates a code generation, which converts each code-entity into a “fake” code-snippet, which seamlessly blends into the original code snippet. The code generation also applies to form-based definitions that do not actually have a code equivalent. The code generation allows the example process 300 to express context information independent of code fragmentation and programming paradigms. The example process 300 also removes the necessity of the LLM to learn to understand both source code and structural information provided in a separate format. The example process 300 can include a code generator which can generate context in a common structural format such as JSON or XML. The example process 300 includes conversion of the prompt into abstract data structures and the subsequent re-generation using the ranking model that increases the versatility of the process application and the possibility of adapting the arrangement of particular code components. The example process 300 also provides an efficient way to analyze code entities for a source code under development to determine if a given code entity is associated to any security issues that require a quick response to preserve system security. The example process 300 can be executed as a time-sensitive operation, to provide ample time to update the software package and to minimize a risk of a malicious attack of vulnerable software source code components.

FIG. 4 is a block diagram of an example computing system 400 used to provide computational functionalities associated with described algorithms, methods, functions, processes, flows, and procedures, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the software code suggestion system 108, described with reference to FIG. 1. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 can provide persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback and input from the user can be received in any form, including acoustic, speech, or tactile input. Other input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented system, comprising: a prompt optimization interface retrieving semantic information characterizing a source code under development, the source code comprising code entities; and a code suggestion system coupled to the prompt optimization interface, the code suggestion system generating, from the semantic information, a dependency graph exposing relations and dependencies between the code entities, the code suggestion system generating a ranked list of code entities indicative of a relevance of each code entity of the code entities in the dependency graph based on a relevance to a query code entity, the code suggestion system minimizing the dependency graph using the ranked list of code entities and a context of the query code entity for generating a minimized dependency graph to be within a set window, and the code suggestion system converting the minimized dependency graph into a prompt format processable by a large language model to generate matching code for the source code under development.

Example 2. The computer-implemented system of the preceding example, wherein the code entities comprise any of classes, methods, functions, forms, statements, variable definitions, and type definitions.

Example 3. The computer-implemented system of any of the preceding examples, wherein the dependency graph comprises a directed multigraph and wherein each node of the directed multigraph represents a code entity, and each edge represents a dependency between two code entities.

Example 4. The computer-implemented system of any of the preceding examples, wherein the code suggestion system parses the source code to extract the code entities.

Example 5. The computer-implemented system of any of the preceding examples, wherein the code suggestion system filters a portion of the code entities to reduce the size of the dependency graph.

Example 6. The computer-implemented system of any of the preceding examples, wherein the code suggestion system generates the ranked list of code entities by applying machine learning models for semantic search, or by using statistical models, or by applying rule-based approaches.

Example 7. The computer-implemented system of any of the preceding examples, further comprising a training engine training the LLM using the semantic information from a Python wrapper library.

Example 8. The computer-implemented system of any of the preceding examples, wherein training the LLM is aligned with inferring the semantic information using an application repository.

Example 9. A computer-implemented method comprising: retrieving, from a prompt optimization interface, semantic information characterizing a source code under development, the source code comprising code entities; generating, from the semantic information, a dependency graph exposing relations and dependencies between the code entities; generating a ranked list of code entities indicative of a relevance of each code entity of the code entities in the dependency graph based on a relevance to a query code entity; minimizing the dependency graph using the ranked code entities and a context of the query code entity for generating a minimized dependency graph; and converting the minimized dependency graph into a prompt format processable by a large language model to generate matching code for the source code under development.

Example 10. The computer-implemented method of the preceding example, wherein the code entities comprise any of classes, methods, functions, forms, statements, variable definitions, and type definitions.

Example 11. The computer-implemented method of any of the preceding examples, wherein the dependency graph comprises a directed multigraph and wherein each node of the directed multigraph represents a code entity, and each edge represents a dependency between two code entities.

Example 12. The computer-implemented method of any of the preceding examples, further comprising parsing the source code to extract the code entities.

Example 13. The computer-implemented method of any of the preceding examples, further comprising filtering a portion of the code entities to reduce the size of the dependency graph.

Example 14. The computer-implemented method of any of the preceding examples, further comprising generating the ranked list of code entities by applying machine learning models for semantic search, or by using statistical models, or by applying rule-based approaches.

Example 15. The computer-implemented method of any of the preceding examples, further comprising training the LLM using the semantic information from a Python wrapper library.

Example 16. The computer-implemented method of any of the preceding examples, wherein training the LLM is aligned with inferring the semantic information using an application repository.

Example 17. A non-transitory computer-readable media encoded with a computer program, the computer program comprising instructions that when executed by one or more computers cause the one or more computers to perform operations comprising: retrieving, from a prompt optimization interface, semantic information characterizing a source code under development, the source code comprising code entities; generating, from the semantic information, a dependency graph exposing relations and dependencies between the code entities; generating a ranked list of code entities indicative of a relevance of each code entity of the code entities in the dependency graph based on a relevance to a query code entity; minimizing the dependency graph using the ranked code entities and a context of the query code entity for generating a minimized dependency graph; and converting the minimized dependency graph into a prompt format processable by a large language model to generate matching code for the source code under development.

Example 18. The non-transitory computer-readable media of the preceding example, wherein the dependency graph comprises a directed multigraph and wherein each node of the directed multigraph represents a code entity, and each edge represents a dependency between two code entities.

Example 19. The non-transitory computer-readable media of any of the preceding examples, wherein the operations further comprise parsing the semantic information to extract the code entities and filtering a portion of the code entities to reduce a size of the dependency graph.

Example 20. The non-transitory computer-readable media of any of the preceding examples, the operations further comprising training the LLM using the semantic information from a Python wrapper library, wherein training the LLM is aligned with inferring the semantic information using an application repository.

What is claimed is:

1. A computer-implemented system, comprising:
a prompt optimization interface retrieving semantic information characterizing a source code under development, the source code comprising code entities; and
a code suggestion system coupled to the prompt optimization interface, the code suggestion system generating, from the semantic information, a dependency graph exposing relations and dependencies between the code entities, the code suggestion system generating a ranked list of code entities indicative of a relevance of each code entity of the code entities in the dependency graph based on a relevance to a query code entity, the code suggestion system minimizing the dependency graph using the ranked list of the code entities and a context of the query code entity for generating a minimized dependency graph to be within a set window, and the code suggestion system converting the minimized dependency graph into a prompt format processable by a large language model to generate matching code for the source code under development.

2. The computer-implemented system of claim 1, wherein the code entities comprise any of classes, methods, functions, forms, statements, variable definitions, and type definitions.

3. The computer-implemented system of claim 1, wherein the dependency graph comprises a directed multigraph and wherein each node of the directed multigraph represents a code entity, and each edge represents a dependency between two code entities.

4. The computer-implemented system of claim 1, wherein the code suggestion system parses the source code to extract the code entities.

5. The computer-implemented system of claim 4, wherein the code suggestion system filters a portion of the code entities to reduce a size of the dependency graph.

6. The computer-implemented system of claim 1, wherein the code suggestion system generates the ranked list of code entities by applying machine learning models for semantic search, or by using statistical models, or by applying rule-based approaches.

7. The computer-implemented system of claim 1, further comprising a training engine training the LLM using the semantic information from a Python wrapper library.

8. The computer-implemented system of claim 7, wherein training the LLM is aligned with inferring the semantic information using an application repository.

9. A computer-implemented method comprising:
retrieving, from a prompt optimization interface, semantic information characterizing a source code under development, the source code comprising code entities;
generating, from the semantic information, a dependency graph exposing relations and dependencies between the code entities;
generating a ranked list of code entities indicative of a relevance of each code entity of the code entities in the dependency graph based on a relevance to a query code entity;
minimizing the dependency graph using the ranked list of code entities and a context of the query code entity for generating a minimized dependency graph; and
converting the minimized dependency graph into a prompt format processable by a large language model to generate matching code for the source code under development.

10. . The computer-implemented method of claim 9, wherein the code entities comprise any of classes, methods, functions, forms, statements, variable definitions, and type definitions.

11. The computer-implemented method of claim 9, wherein the dependency graph comprises a directed multigraph and wherein each node of the directed multigraph represents a code entity, and each edge represents a dependency between two code entities.

12. The computer-implemented method of claim 9, further comprising:
parsing the source code to extract the code entities.

13. The computer-implemented method of claim 12, further comprising:
filtering a portion of the code entities to reduce a size of the dependency graph.

14. The computer-implemented method of claim 9, further comprising:
generating the ranked list of code entities by applying machine learning models for semantic search, or by using statistical models, or by applying rule-based approaches.

15. The computer-implemented method of claim 9, further comprising:
training the LLM using the semantic information from a Python wrapper library.

16. The computer-implemented method of claim 15, wherein training the LLM is aligned with inferring the semantic information using an application repository.

17. A non-transitory computer-readable media encoded with a computer program, the computer program comprising instructions that when executed by one or more computers cause the one or more computers to perform operations comprising:
retrieving, from a prompt optimization interface, semantic information characterizing a source code under development, the source code comprising code entities;
generating, from the semantic information, a dependency graph exposing relations and dependencies between the code entities;
generating a ranked list of code entities indicative of a relevance of each code entity of the code entities in the dependency graph based on a relevance to a query code entity;
minimizing the dependency graph using the ranked list of code entities and a context of the query code entity for generating a minimized dependency graph; and
converting the minimized dependency graph into a prompt format processable by a large language model to generate matching code for the source code under development.

18. The non-transitory computer-readable media of claim 17, wherein the dependency graph comprises a directed multigraph and wherein each node of the directed multigraph represents a code entity, and each edge represents a dependency between two code entities.

19. The non-transitory computer-readable media of claim 17, the operations further comprising:
parsing the source code to extract the code entities; and
filtering a portion of the code entities to reduce a size of the dependency graph.

20. The non-transitory computer-readable media of claim 17, the operations further comprising:
training the LLM using the semantic information from a Python wrapper library, wherein training the LLM is aligned with inferring the semantic information using an application repository.
